(19) United States
(12) Patent Application Publication
(10) Pub. No.: US 2014/0335427 A1
(43) Pub. Date: Nov. 13, 2014

(54) ELECTROLYTE FOR LITHIUM SECONDARY BATTERY AND LITHIUM SECONDARY BATTERY EMPLOYING THE SAME

(71) Applicant: Samsung SDI Co., Ltd., Yongin-si (KR)

(72) Inventors: Makhmut Khasanov, Yongin-si (KR); Vladimir Egorov, Yongin-si (KR); Pavel Alexandrovich Shatunov, Yongin-si (KR); Alexey Tereshchenko, Yongin-si (KR); Denis Chernyshov, Yongin-si (KR); Jung-Yi Yu, Yongin-si (KR); SANG-IL HAN, Yongin-si (KR); Sang-Hoon Kim, Yongin-si (KR); Duck-Hyun Kim, Yongin-si (KR); Myung-Hwan Jeong, Yongin-si (KR); Seung-Tae Lee, Yongin-si (KR); Tae-Hyun Bae, Yongin-si (KR); Mi-Hyun Lee, Yongin-si (KR); Eon-Mi Lee, Yongin-si (KR); Ha-Rim Lee, Yongin-si (KR); Moon-Sung Kim, Yongin-si (KR); In-Haeng Cho, Yongin-si (KR); E-Rang Cho, Yongin-si (KR); Dong-Myung Choi, Yongin-si (KR); Woo-Cheol Shin, Yongin-si (KR)

(73) Assignee: Samsung SDI Co., Ltd., Yongin-si (KR)

(21) Appl. No.: 14/026,412

(22) Filed: Sep. 13, 2013

(30) Foreign Application Priority Data
May 7, 2013 (KR) 10-2013-0051496

(51) Int. Cl. H01M 10/0567; H01M 10/052

(52) U.S. Cl. CPC H01M 10/0567; H01M 10/052
USPC 429/338; 429/188; 429/342; 429/341; 429/339; 429/340; 429/337; 429/199

(57) ABSTRACT

An electrolyte for a lithium secondary battery and a lithium secondary battery including the electrolyte are provided. The electrolyte includes a compound represented by Formula 1 below; a nonaqueous organic solvent; and a lithium salt:

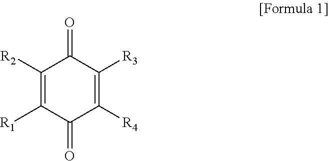

wherein, in Formula 1, R¹, R², R³, and R⁴ are each independently a unsubstituted or substituted C1-C20 alkoxy group, a unsubstituted or substituted C1-C20 alkoxyalkyleneoxy group, a unsubstituted or substituted C₆-C₂₀ aryloxy group, or R—O—C(═O)— where R is a C1-C20 alkyl group, a C6-C20 aryl group, or a C1-C20 fluoroalkyl group.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the benefit of Korean Patent Application No. 10-2013-0051496, filed on May 7, 2013, in the Korean Intellectual Property Office, the disclosure of which is incorporated herein by reference.

### BACKGROUND

1. Field

One or more embodiments relate to an electrolyte for lithium secondary batteries, and a lithium secondary battery including the electrolyte.

2. Description of the Related Technology

Recently, lithium batteries have drawn significant attention as power sources for small portable electronic devices. Lithium batteries that use an organic electrolytic solution discharge voltage that is about twice as high as those that use an aqueous alkali electrolytic solution and a higher energy density than those that use aqueous alkali electrolytic solution.

As cathode active materials for lithium secondary batteries, lithium-transition metal oxides, such as LiCoO₂, LiMn₂O₄, and LiNi₁₋ₓCoₓO₂ (where 0<x<1), which have a structure that allows intercalation of lithium ions, are mainly used. Carbonaceous materials in various forms, such as artificial graphite, natural graphite and hard carbon, which allow intercalation and deintercalation of lithium ions, have been used as anode active materials.

During initial charging of a lithium secondary battery, lithium ions from a cathode active material such as lithium metal oxide migrate toward an anode active material such as graphite and are intercalated into interlayer of the anode active material. Lithium ions with high reactivity may react with carbon from electrolytic solution or the anode active material on a surface of the anode active material, such as graphite, thus forming a compound such as Li₂CO₃, Li₂O, or LiOH. These compounds may form a solid electrolyte interface (SEI) layer on the surface of the anode active material.

However, during charging of a lithium battery, the thickness of the lithium battery may expand due to a gas such as CO, CO₂, CH₄, or C₂H₆ generated from the decomposition of a carbonate-based solvent during the formation of the SEI layer. When a fully-charged lithium battery is left at a high temperature for a long time, the SEI layer may be decomposed due to increases in electrochemical energy and thermal energy, so that the surface of the anode may be exposed to be vulnerable to side reactions with nearby electrolyte solution. Continuous generation of gas from the side reaction may raise the internal pressure of the lithium battery, and consequently deteriorate high-temperature storage stability.

To address these drawbacks, research has been conducted, for example, into changing the reaction appearance involved in the formation of the SEI layer, for example, by varying the composition of the carbonate-based organic solvent or by adding a specific additive.

However, electrolytes for lithium secondary batteries known so far do not have satisfactory high-rate charge/discharge characteristics, cycle lifetime, low-temperature discharge characteristics, and high-temperature discharge characteristics, thereby improvement in this regard still being necessary.

### SUMMARY

One or more embodiments include an electrolyte for lithium secondary batteries, and a lithium secondary battery including the electrolyte and having improved cycle lifetime.

Additional aspects will be set forth in part in the description which follows and, in part, will be apparent from the description, or may be learned by practice of the presented embodiments.

According to one or more embodiments, an electrolyte for a lithium secondary battery includes: a compound represented by Formula 1 below; a nonaqueous organic solvent; and a lithium salt:

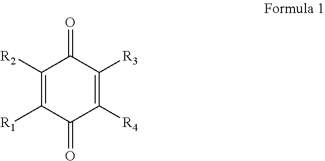

wherein, in Formula 1, R¹, R², R³, and R⁴ are each independently a unsubstituted or substituted C1-C20 alkoxy group, a unsubstituted or substituted C1-C20 alkoxyalkyleneoxy group, a unsubstituted or substituted C₆-C₂₀ aryloxy group, or R—O—C(═O)— where R is a C1-C20 alkyl group, a C₆-C₂₀ aryl group, or a C1-C20 fluoroalkyl group.

According to one or more embodiments, a lithium secondary battery includes: an anode including an anode active material including a material allowing reversible intercalation and deintercalation of lithium ions, lithium metal, a lithium metal alloy, a material allowing doping or undoping of lithium, or a transition metal oxide; a cathode including a cathode active material allowing reversible intercalation and deintercalation of lithium; and a reaction product of the electrolyte defined above.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic view of a lithium secondary battery according to an embodiment;

FIG. 2 is a graph illustrating lifetime characteristics of coin full-cells of Manufacture Examples 1-3 and Comparative Manufacture Example 1;

FIG. 3 is a graph illustrating lifetime characteristics of coin full-cells of Manufacture Examples 4 and 5 and Comparative Manufacture Examples 2 and 3;

FIGS. 4 to 6 are graph illustrating the results of cyclic voltammetry evaluation on triode cells using the electrolytes of Examples 6 and 7 and Comparative Example 1;

FIG. 7 is a graph of dQ/dV versus voltage in the coin full cells of Manufacture Examples 4 and 5 and Comparative Manufacture Example 2, illustrating initial discharging characteristics at 0.2 C rate; and

FIG. 8 is a spectrum illustrating the results of Fourier-transform infrared spectroscopy (FT-IR) on the anodes of the coin full cells of Manufacture Examples 4 and 5, and Comparative Manufacture Example 1.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

According to an embodiment, an electrolyte for a lithium secondary battery includes a nonaqueous organic solvent, a lithium salt, and a compound represented by Formula 1 below:

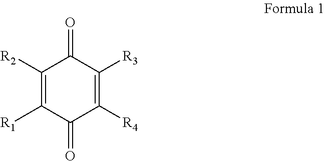

In Formula 1, R¹, R², R³, and R⁴ are each independently a unsubstituted or substituted C1-C20 alkoxy group, a unsubstituted or substituted C1-C20 alkoxyalkyleneoxy group, a unsubstituted or substituted C₆-C₂₀ aryloxy group, or R—O—C(═O)— where R is a C1-C20 alkyl group, a C₆-C₂₀ aryl group, or a C1-C20 fluoroalkyl group.

When the compound of Formula 1 is used as an additive in the electrolyte, the compound of Formula 1 may be reduced during a first charging process of a lithium secondary battery to form a stable solid electrolyte interface (SEI) layer as a passivation layer on the surface of an anode. The reduction of the compound of Formula 1 may be identified by cyclic voltammetry and based on dQ/dV data. A reaction product of the compound of Formula 1, i.e., a decomposition product in the SEI layer may be identified by Fourier transform infrared spectroscopy (FT-IR).

The SEI layer, which serves as an ion tunnel, may pass exclusively lithium ions. This ion tunnel effect of the SEI layer may block large-molecular weight organic solvent molecules in the electrolyte from migrating along with lithium ions and being intercalated into an anode active material, and consequently prevent damaging the anode. The SEI layer blocks contact between the electrolyte and the anode active material not to cause decomposition of the electrolyte to maintain the amount of lithium ions in the electrolyte constant to allow reversible and stable charging and discharging.

The use of the compound of Formula 1 as an additive in the electrolyte may facilitate formation of the SEI layer. Decomposition of the compound of Formula 1 may be controlled to occur before reduction of main electrolyte components so that the SEI layer may maintain high stability and low resistance. Consequently, the SEI layer may prevent contact between the electrolyte and anode active material during charge-discharge cycles, so that a lithium secondary battery may have improved cycle characteristics, improved lifetime, improved discharge capacity, and improved high-rate characteristics.

The compound of Formula 1 may be, for example, a compound of Formula 2 below or a compound of Formula 3 below.

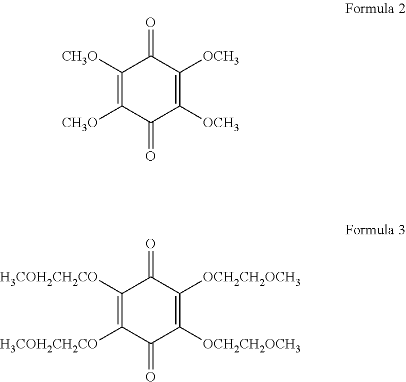

An amount of the compound of Formula 1 may be from about 0.01 wt % to about 5 wt %, and in some embodiments, from about 0.1 wt % to about 2.5 wt %. When the amount of the compound of Formula 1 is within these ranges, the lithium secondary battery may have improved cycle characteristics.

As used herein, the alkyl group as a substituent refers to a linear or branched, saturated monovalent hydrocarbon moiety having 1 to 20 carbon atoms, for example 1 to 10 carbon atoms or 1 to 6 carbon atoms, for example 1 to 6 carbon atoms. Examples of the unsubstituted alkyl group are methyl, ethyl, propyl, isobutyl, sec-butyl, tert-butyl, pentyl, iso-amyl, and hexyl. At least one hydrogen atom in the alkyl group may be substituted with a halogen atom, a hydroxy group, a nitro group, a cyano group, a substituted or unsubstituted amino group (—NH₂, —NH(R), or —N(R′)(R″) where R′ and R″ are each independently a C1-C10 alkyl group), an amidino group, a hydrazine, a hydrazone, a carboxyl group, a sulfonic acid group, a phosphoric acid group, a C1-C20 alkyl group, a C1-C20 halogenated alkyl group, a C2-C20 alkenyl group, a C2-C20 alkynyl group, a C1-C20 heteroalkyl group, a C6-C20 aryl group, a C7-C20 arylalkyl group, a C6-C20 heteroaryl group, or a C7-C20 heteroarylalkyl group.

As used herein, the term “alkoxy” represents “alkyl-O—”, wherein the alkyl is the same as described above. Non-limiting examples of the alkoxy group include methoxy, ethoxy, propoxy, 2-propoxy, butoxy, t-butoxy, pentyloxy, hexyloxy, cyclopropoxy, and cyclohexyloxy. At least one hydrogen atom of the alkoxy group may be substituted with the same substituents as those recited above in conjunction with the alkyl group.

As used herein, the term “alkoxyalkyleneoxy” group refers to CnH2n+10CmH2mO— or CnH2n+10CmH2mO— where n and m are each independently 1, 2, or 3. Examples of the alkoxyalkyleneoxy group are CH3OCH2CH2O— or C2H5OCH2CH2CH2O—.

At least one hydrogen atom of the alkoxyalkyleneoxy group may be substituted with the same substituents as those recited above in conjunction with the alkyl group.

As used herein, the term “aryl” group, which is used alone or in combination, refers to an aromatic hydrocarbon containing at least one ring.

The term “aryl” is construed as including a group with an aromatic ring fused to at least one cycloalkyl ring.

Non-limiting examples of the aryl group are phenyl, naphthyl, and tetrahydronaphthyl.

At least one hydrogen atom in the aryl group may be substituted with the same substituent as those recited above in connection with the alkyl group.

As used herein, the term “aryloxy” group refers to “—O-aryl”. An example of the aryloxy group is phenoxy. At least one hydrogen atom in the aryloxy group may be substituted with the same substituents as those recited above in conjunction with the alkyl group.

The nonaqueous organic solvent functions as a migration medium of ions involved in electrochemical reactions in batteries.

Non-limiting examples of the nonaqueous organic solvent are at least one selected from the group consisting of a carbonate-based solvent, an ester-based solvent, an ether-based solvent, a ketone-based solvent, an alcohol-based solvent, and an aprotic solvent.

Non-limiting examples of the carbonate-based solvent are dimethyl carbonate (DMC), diethyl carbonate (DEC), dipropyl carbonate (DPC), methylpropyl carbonate (MPC), ethylpropyl carbonate (EPC), methyl ethyl carbonate (MEC), ethylene carbonate (EC), propylene carbonate (PC), and butylene carbonate (BC). Examples of the ester-based solvent are methyl acetate, ethyl acetate, n-propyl acetate, dimethyl acetate, methyl propionate, ethyl propionate, γ-butyrrolactone, decanolide, valerolactone, mevalonolactone, and caprolactone.

Non-limiting examples of the ether-based solvent are dibutyl ether, tetraglyme, diglyme, dimethoxyethane, 2-methyltetrahydrofuran, and tetrahydrofuran. An example of the ketones available as the nonaqueous organic solvent may be cyclohexanone. Non-limiting examples of the alcohol-based solvent are ethyl alcohol and isopropyl alcohol. Non-limiting examples of the aprotic solvent are nitrils, such as R—CN (wherein R is a straight, branched or cyclic C2-C20 hydrocarbon group, which may have a double-bonded aromatic ring or an ether bond); amides, such as dimethylformamide; dioxolanes, such as 1,3-dioxolane; and sulfolanes.

These nonaqueous organic solvents may be used alone or in combination of at least two thereof. A mixing ratio of the two of the nonaqueous organic solvents may appropriately varied depending on the desired performance of a battery, which will be obvious to one of ordinary skill in the art.

The carbonate-based solvent may be a combination of cyclic carbonate and chain carbonate. For example, a combination of cyclic carbonate and chain carbonate in a volume ratio of about 1:1 to about 1:9 may be used to improve performance of the electrolyte.

The nonaqueous organic solvent may further include an aromatic hydrocarbon-based organic solvent in a carbonate-based solvent. In this regard, the carbonate-based solvent and the aromatic hydrocarbon-based organic solvent may be mixed, for example, in a volume ratio of about 1:1 to about 30:1.

An example of the aromatic hydrocarbon-based organic solvent is an aromatic hydrocarbon-based compound represented by Formula 4 below:

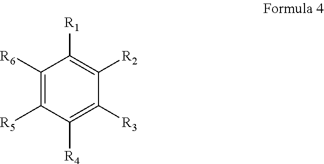

In Formula 4, R₁ to R₆ are each independently a hydrogen atom, a halogen atom, a C1-C10 alkyl group, a C1-C10 haloalkyl group or a combination thereof.

Non-limiting examples of the aromatic hydrocarbon-based organic solvent are benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and combinations thereof.

To improve lifetime of a lithium secondary battery, the nonaqueous electrolyte may further include vinylene carbonate or an ethylene carbonate-based compound of Formula 5 below.

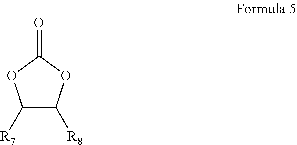

In Formula 5, R₇ and R₈ are each independently a hydrogen atom, a halogen atom, a cyano group (CN), a nitro group (NO₂), or a C1-C5 fluoroalkyl group, at least one of R₇ and R₈ being a halogen group, a cyano group (CN), a nitro group (NO₂) or a C1-C5 fluoroalkyl group.

Non-limiting examples of the ethylene carbonate-based compound are difluoro ethylene carbonate, chloroethylene carbonate, dichloroethylene carbonate, bromoethylene carbonate, dibromoethylene carbonate, nitroethylene carbonate, cyanoethylene carbonate, and fluoroethylene carbonate. When vinylene carbonate or the ethylene carbonate-based compound of Formula 5 is used, an amount thereof may be appropriately controlled to improve lifetime of a lithium battery.

The lithium salt is dissolved in the nonaqueous organic solvent and serves as a source of lithium ions in a lithium secondary battery, thereby enabling the basic operation of the lithium secondary battery. The lithium salt also facilitates the migration of lithium ions between the cathode and the anode. Non-limiting examples of the lithium salt are LiPF₆, LiBF₄, LiSbF₆, LiAsF₆, LiC₄F₉SO₃, LiClO₄, LiAlO₂, LiAlCl₄,

LiN(CₓF₂ₓ₊₁SO₂)(C_{y}F_{2y+1}SO₂) (where x and y are natural numbers), LiCl, LiI, LiB(C₂O₄)₂ (lithium bis(oxalato) borate, LiBOB) or a combination thereof. The concentration of the lithium salt may be in the range of about 0.1M to about 2.0M.

When the concentration of the lithium salt is within this range, the electrolyte may an appropriate conductivity and an appropriate viscosity, and thus may improve performance of the electrolyte, and allow lithium ions to effectively migrate.

According to anther embodiment, a lithium secondary battery includes: an anode including an anode active material including a material allowing reversible intercalation and deintercalation of lithium ions, lithium metal, a lithium metal alloy, a material allowing doping or undoping of lithium, or a transition metal oxide; a cathode including a cathode active material allowing reversible intercalation and deintercalation of lithium; and a reaction product of the electrolytes according to the above-described embodiments.

The electrolyte may include a nonaqueous organic solvent, a lithium salt, and a compound represented by Formula 1 above, as described above.

Hereinafter, a method of manufacturing a lithium secondary battery using any of the electrolytes according to the above-described embodiments will now be described with reference to a lithium secondary battery including a cathode, an anode, an electrolyte, and a separator.

The cathode and the anode may be manufactured by coating a cathode active material layer composition and an anode active material layer composition on current collectors, respectively, and drying the resulting products.

The cathode active material layer composition may be prepared by mixing a cathode active material, a conducting agent, a binder, and a solvent.

A compound (lithiated intercalation compound) which allows reversible intercalation and deintercalation of lithium may be used as the cathode active material.

The cathode active material may be at least one selected from among lithium-cobalt oxide (LiCoO₂); lithium-nickel oxide (LiNiO₂); a lithium-manganese oxide, for example, Li₁₊ₓMn₂₋ₓO₄ (where x is from 0 to 0.33), LiMnO₃, LiMn₂O₃, or LiMnO₂; lithium-copper oxide (Li₂CuO₂); lithium-iron oxide (LiFe₃O₄); lithium-vanadium oxide (LiV₃O₈); copper-vanadium oxide (Cu₂V₂O₇); vanadium oxide (V₂O₅); a Ni-site type lithium-nickel oxide of LiNi₁₋ₓMₓO₂ (where M=Co, Mn, Al, Cu, Fe, Mg, B, or Ga, and x is from 0.01 to 0.3); a lithium-manganese composite oxide of LiMn₂₋ₓMₓO₂ (where M=Co, Ni, Fe, Cr, Zn, or Ta, and x is from 0.01 to 0.1) or Li₂Mn₃MO₈ (where M=Fe, Co, Ni, Cu, or Zn); a lithium manganese oxide of LiMn₂O₄ of which part of lithium is substituted with alkali earth metal ion; a disulfide compound; and an iron-molybdenum oxide (Fe₂(MoO₄)₃).

The cathode active material may be, for example, a mixture of lithium cobalt oxide and lithium nickel cobalt manganese oxide.

The binder may be any binder available in the art that is able to bind cathode active material particles together or to a current collector. For example, the binder may be at least one of polyvinyl alcohol, carboxymethyl cellulose, hydroxypropyl cellulose, diacetyl cellulose, polyvinyl chloride, carboxylated polyvinyl chloride, polyvinyl fluoride, a polymers including ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon.

The cathode active material may include at least one selected from the group consisting of lithium cobalt oxide, lithium nickel cobalt manganese oxide, lithium nickel cobalt aluminum oxide, lithium iron phosphorous oxide, and lithium manganese oxide. The cathode active material is not limited to these examples, and may be any cathode active material available in the art.

For example, the cathode active material may be a compound represented by one of the following formula: LiₐA_{1-b}B_{b}D₂ (where 0.90≦a≦1.8, and 0≦b≦0.5); LiₐE_{1-b}B_{b}O_{2-c}D_{c} (where 0.90≦a≦1.8, 0≦b≦0.5, and 0≦c≦0.05); LiₐE_{2-b}B_{b}O_{4-c}D_{c} (where 0≦b≦0.5, and 0≦c≦0.05); LiₐNi_{1-b-c}Co_{b}B_{c}D_{α} (where 0.90≦a≦1.8, 0≦b≦0.5, 0≦c≦0.05, and 0≦α≦2); LiₐNi_{1-b-c}CO_{b}B_{c}O_{2-α}F_{α} (where 0.90≦a≦1.8, 0≦b≦0.5, 0≦c≦0.05, and 0≦α≦2); LiₐNi_{1-b-c}CO_{b}B_{c}O_{2-α}F₂ (where 0.90≦a≦1.8, 0≦b≦0.5, 0≦c≦0.05, and 0≦α≦2); LiₐNi_{1-b-c}Mn_{b}B_{c}D_{α} (where 0.90≦a≦1.8, 0≦b≦0.5, 0≦c≦0.05, and 0≦α≦2); LiₐNi_{1-b-c}Mn_{b}B_{c}O_{2-α}F_{α} (where 0.90≦a≦1.8, 0≦b≦0.5, 0≦c≦0.05, and 0≦α≦2); LiₐNi_{1-b-c}Mn_{b}B_{c}O_{2-α}F₂ (where 0.90≦a≦1.8, 0≦b≦0.5, 0≦c≦0.05, and 0≦α≦2); LiₐNi_{b}E_{c}G_{d}O₂ (where 0.90≦a≦1.8, 0≦b≦0.9, 0≦c≦0.5, and 0.001≦d≦0.1); LiₐNi_{b}Co_{c}Mn_{d}GeO₂ (where 0.90≦a≦1.8, 0≦b≦0.9, 0≦c≦0.5, 0≦d≦0.5, and 0.001≦e≦0.1); LiₐNiG_{b}O₂ (where 0.90≦a≦1.8, and 0.001≦b≦0.1); LiₐCoG_{b}O₂ (where 0.90≦a≦1.8, and 0.001≦b≦0.1); LiₐMnG_{b}O₂ (where 0.90≦a≦1.8, 0.001≦b≦0.1); LiₐMn₂G_{b}O₄ (where 0.90≦a≦1.8, 0.001≦b≦0.1); QO₂; QS₂; LiQS₂; V₂O₅; LiV₂O₅; LiIO₂; LiNiVO₄; Li_{(3-f)}J₂(PO₄)₃ (where 0≦f≦2); Li_{(3-f)}Fe₂(PO₄)₃ (where 0≦f≦2); and LiFePO₄.

In the formulae above, A is selected from the group consisting of nickel (Ni), cobalt (Co), manganese (Mn), and combinations thereof; B is selected from the group consisting of aluminum (Al), nickel (Ni), cobalt (Co), manganese (Mn), chromium (Cr), iron (Fe), magnesium (Mg), strontium (Sr), vanadium (V), a rare earth element, and combinations thereof; D is selected from the group consisting of oxygen (O), fluorine (F), sulfur (S), phosphorus (P), and combinations thereof; E is selected from the group consisting of cobalt (Co), manganese (Mn), and combinations thereof; F is selected from the group consisting of fluorine (F), sulfur (S), phosphorus (P), and combinations thereof; G is selected from the group consisting of aluminum (Al), chromium (Cr), manganese (Mn), iron (Fe), magnesium (Mg), lanthanum (La), cerium (Ce), strontium (Sr), vanadium (V), and combinations thereof; Q is selected from the group consisting of titanium (Ti), molybdenum (Mo), manganese (Mn), and combinations thereof; I is selected from the group consisting of chromium (Cr), vanadium (V), iron (Fe), scandium (Sc), yttrium (Y), and combinations thereof; and J is selected from the group consisting of vanadium (V), chromium (Cr), manganese (Mn), cobalt (Co), nickel (Ni), copper (Cu), and combinations thereof.

The compounds listed above as cathode active materials may have a surface coating layer (hereinafter, “coating layer”). Alternatively, a mixture of a compound without having a coating layer and a compound having a coating layer, the compounds being selected from the compounds listed above, may be used. The coating layer may include at least one compound of a coating element selected from the group consisting of oxide, hydroxide, oxyhydroxide, oxycarbonate, and hydroxycarbonate of the coating element. The compounds for the coating layer may be amorphous or crystalline. The coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or mixtures thereof. The coating layer may be formed using any method that does not adversely affect the physical properties of the cathode active material when a compound of the coating element is used. For example, the coating layer may be formed using a spray coating method, a dipping method, or the like. This is obvious to those of skill in the art, and thus a detailed description thereof will be omitted.

The amount of the binder may be from about 1 part to about 50 parts by weight based on 100 parts by weight of the total weight of the cathode active material. Non-limiting examples of the binder are polyvinylidene fluoride (PVDF), polyvinyl alcohols, carboxymethylcellulose (CMC), starch, hydroxypropylcellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluoro rubber, and various copolymers. The amount of the binder may be from about 2 parts to about 5 parts by weight based on 100 parts by weight of the total weight of the cathode active material. When the amount of the binder is within this range, the cathode active material layer may bind strongly to the current collector.

The conducting agent is not particularly limited, and may be any material as long as it has an appropriate conductivity without causing chemical changes in the fabricated battery. Non-limiting examples of the conducting agent are graphite such as natural or artificial graphite; carbonaceous materials such as carbon black, acetylene black, ketjen black, channel black, furnace black, lamp black, and thermal black; conductive fibers such as carbon fibers and metallic fibers; metallic powders such as carbon fluoride powder, aluminum powder, and nickel powder; conductive whiskers such as zinc oxide and potassium titanate; conductive metal oxides such as titanium oxide; and other conductive materials such as polyphenylene derivatives.

The amount of the conducting agent may be from about 2 parts to about 5 parts by weight based on 100 parts by weight of the total weight of the cathode active material. When the amount of the conducting agent is within this range, the cathode may have better conductive characteristics.

A non-limiting example of the solvent is N-methylpyrrolidone (NMP).

The amount of the solvent may be from about 100 parts to about 2000 parts by weight based on 100 parts by weight of the cathode active material. When the amount of the solvent is within this range, forming the cathode active material layer may be facilitated.

A cathode current collector is fabricated to have a thickness of from about 3 μm to about 500 μm, and may be any current collector as long as it has high conductivity without causing chemical changes in the fabricated battery. Examples of the cathode current collector include stainless steel, aluminum, nickel, titanium, thermal-treated carbon, and aluminum or stainless steel that is surface-treated with carbon, nickel, titanium, or silver. The cathode current collector may be processed to have fine irregularities on a surface thereof so as to enhance an adhesive strength of the current collector to the cathode active material. The cathode current collector may be in any of various forms, including a film, a sheet, a foil, a net, a porous structure, foam, and non-woven fabric.

Apart from the cathode active material layer composition prepared above, a composition for forming an anode active material layer is prepared using an anode active material, a binder, a conducting agent, and a solvent together.

The anode active material may be a material that allows intercalation and deintercalation of lithium ions. Non-limiting examples of the anode active material are graphite, carbon, lithium metal, lithium alloys, and silicon oxide-based materials. In one embodiment, the anode active material may be silicon oxide.

Examples of the carbonaceous material are crystalline carbon, amorphous carbon, and mixtures thereof. Non-limiting examples of the crystalline carbon are graphite, such as natural graphite or artificial graphite that are in amorphous, plate, flake, spherical or fibrous form. Non-limiting examples of the amorphous carbon are soft carbon (carbon sintered at low temperatures), hard carbon, meso-phase pitch carbides, sintered corks, graphene, carbon black, fullerene soot, carbon nanotubes, and carbon fibers. Any appropriate material available in the art may be used.

The amount of the binder may be from about 1 part to about 50 parts by weight based on 100 parts by weight of the total weight of the anode active material. Non-limiting examples of the binder are those described in connection with the cathode.

The amount of the conducting agent may be from about 1 part to about 5 parts by weight based on 100 parts by weight of the anode active material. When the amount of the conducting agent is within this range, the anode may have better conductive characteristics.

The amount of the solvent may be from about 100 parts to about 2000 parts by weight based on 100 parts by weight of the anode active material. When the amount of the solvent is within this range, forming the anode active material layer may be facilitated.

The same kinds of conducting agents and solvents as those used in the cathode may be used.

An anode current collector is fabricated to have a thickness of about 3 μm to about 500 μm. The anode current collector is not particularly limited, and may be any material as long as it has an appropriate conductivity without causing chemical changes in the fabricated battery. Non-limiting examples of the anode current collector are copper, stainless steel, aluminum, nickel, titanium, thermal-treated carbon, copper or stainless steel that is surface-treated with carbon, nickel, titanium or silver, and aluminum-cadmium alloys. In addition, similar to the cathode current collector, the anode current collector may be processed to have fine irregularities on a surface thereof so as to enhance the adhesive strength of the anode current collector to the anode active material, and may be used in any of various forms, including a film, a sheet, a foil, a net, a porous structure, foam, and non-woven fabric.

The separator is disposed between the positive and anodes manufactured according to the processes described above.

The separator may have a pore diameter of about 0.01 μm to about 10 μm, and a thickness of about 5 μm to about 20 μm. Examples of the separator are olefin-based polymers, such as polypropylene, having resistance to chemicals and hydrophobic properties, and sheets or non-woven fabric made of glass fiber or polyethylene. When a solid electrolyte, for example, a polymer electrolyte, is used, the solid electrolyte may also serve as the separator.

The separator may be a monolayer or a multilayer including at least two layers of olefin-based polymer, for example, polyethylene, polypropylene, polyvinylidene fluoride, or a combination thereof. The multilayer may be a mixed multilayer. For example, the separator may be a two-layered separator including polyethylene and polypropylene layers, a three-layered separator including polyethylene, polypropylene and polyethylene layers, or a three-layered separator including polypropylene, polyethylene and polypropylene layers.

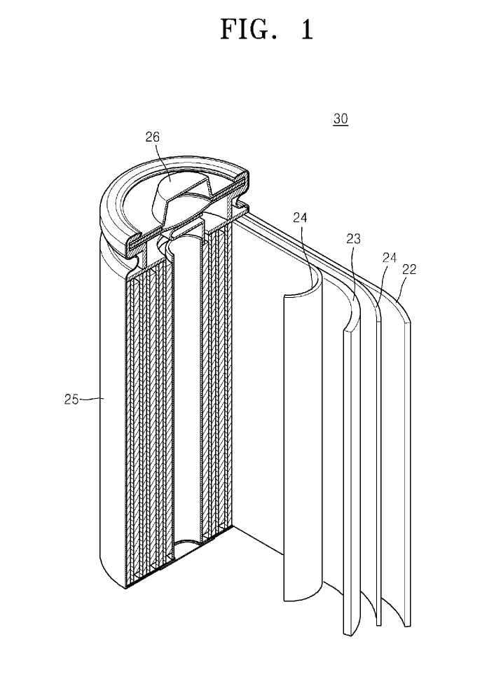

FIG. 1 is a schematic perspective view of a lithium secondary battery 30 according to an embodiment.

Referring to FIG. 1, the lithium secondary battery 30 includes a cathode 23, an anode 22, a separator 24 between the cathode 23 and the anode 22, an electrolyte (not shown) impregnated into the cathode 23, the anode, and the separate 24, a battery case 25, and a sealing member 26 for sealing the battery case 25. The lithium battery 30 is manufactured by sequentially stacking the cathode 23, the anode 22, and the separator 24 on one another to form a stack, rolling the stack into a spiral form, and inserting the rolled-up stack into the battery case 25. The battery case 25 may be sealed with the sealing member 26, thereby completing the manufacture of the lithium secondary battery 30.

Hereinafter, one or more embodiments will be described in further detail with reference to the following examples. These examples are not intended to limit the purpose and scope of the one or more embodiments.

### Preparation Example 1

### Preparation of Compound of Formula 2

Tetramethyl-1,4-benzoquinone represented by Formula 2 was prepared as follows.

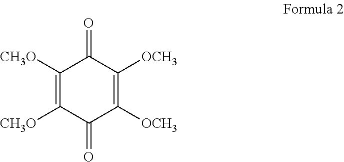

A solution of sodium methoxide (0.04 mole) in methanol (50 ml) was cooled, followed by a dropwise addition of tetrachloro-1,4-benzoquinone (0.01 mole) thereinto.

The reaction mixture was refluxed for about 30 minutes, and then filtered in hot condition immediately after completion of the reaction. The filtrate was cooled down to obtain tetramethoxy-1,4-benzoquinone in crystalline form, which was then recrystallized using methanol to obtain tetramethoxy-1,4-benzoquinone of Formula 2 as a target compound.

Melting point: 134-135° C.

Yield: 46%

¹H NMR (400 MHz, CDCl₃): δ 3.98 (s, 12H)

¹³C NMR (100.5 MHz, CDCl₃): δ 61.44, 142.81, 180.76

### Preparation Example 2

### Preparation of Compound of Formula 3

Tetrakis-(2-methoxyethoxy)-1,4-benzoquinone represented by Formula 3 was prepared as follows.

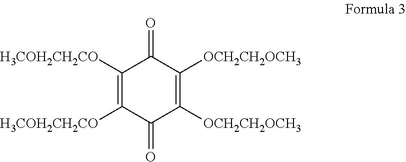

A solution of sodium 2-methoxyethoxide (0.04 mole) in 2-methoxyethanol (50 ml) was cooled, followed by a dropwise addition of tetrachloro-1,4-benzoquinone (0.01 mole) thereinto.

The reaction mixture was refluxed for about 30 minutes, and then filtered in hot condition immediately after completion of the reaction. The filtrate was cooled down, and separated by flash chromatography (using CHCl₃ as eluent) to obtain a crude product, which was then recrystallized using diethyl ether to obtain tetrakis-(2-methoxyethoxy)-1,4-benzoquinone of Formula 3 as a target compound.

Melting point: 50-52° C.

Yield: 42%

¹H NMR (400 MHz, CDCl₃): δ 3.37 (s, 12H), 3.64 (m, 8H), 4.34 (m, 8H).

¹³C NMR (100.5 MHz, CDCl₃): δ 59.06, 71.64, 72.77, 142.70, 180.39.

### Example 1

### Preparation of Electrolyte

LiPF₆ was added into dimethyl carbonate (DMC) as a nonaqueous organic solvent to a concentration of 1M, followed by an addition of 0.8 wt % of the compound of Formula 3 to prepare an electrolyte.

### Examples 2 and 3

### Preparation of Electrolyte

Electrolytes were prepared in the same manner as in Example 1, except that the amounts of the compound of Formula 3 were about 1.6 wt % and about 2.4 wt %, respectively.

### Example 4

### Preparation of Electrolyte

An electrolytes were prepared in the same manner as in Example 1, except that a mixture of ethylene carbonate (EC) and dimethyl carbonate (DMC) (3:7 by volume ratio), instead of dimethyl carbonate, was used as a nonaqueous organic solvent, and 0.2 wt % of the compound of Formula 2, instead of 0.8 wt % of the compound of Formula 3, was used.

### Example 5

### Preparation of Electrolyte

An electrolytes were prepared in the same manner as in Example 1, except that a mixture of ethylene carbonate (EC) and dimethyl carbonate (DMC) (3:7 by volume ratio), instead of dimethyl carbonate, was used as a nonaqueous organic solvent, and 0.4 wt % of the compound of Formula 3, instead of 0.8 wt % of the compound of Formula 3, was used.

### Example 6

### Preparation of Electrolyte

LiPF₆ was added into dimethyl carbonate (DMC) as a nonaqueous organic solvent to a concentration of 1M, followed by an addition of 0.2 wt % of the compound of Formula 2 to prepare an electrolyte.

### Example 7

### Preparation of Electrolyte

LiPF₆ was added into dimethyl carbonate (DMC) as a nonaqueous organic solvent to a concentration of 1M, followed by an addition of 0.4 wt % of the compound of Formula 3 to prepare an electrolyte.

### Comparative Example 1

### Preparation of Electrolyte

LiPF₆ was added into dimethyl carbonate (DMC) as a nonaqueous organic solvent to a concentration of 1M to prepare an electrolyte.

### Comparative Example 2

### Preparation of Electrolyte

LiPF₆ was added into a mixture of ethylene carbonate (EC) and dimethyl carbonate (DMC) (3:7 by volume ratio) to a concentration of 1M to prepare an electrolyte.

### Comparative Example 3

### Preparation of Electrolyte

An electrolytes were prepared in the same manner as in Example 1, except that a mixture of ethylene carbonate (EC) and dimethyl carbonate (DMC) (3:7 by volume ratio), instead of dimethyl carbonate, was used as a nonaqueous organic solvent, and 0.2 wt % of 2-methoxy-1,4-benzoquinone, instead of 0.8 wt % of the compound of Formula 3, was used.

### Manufacture Example 1

### Manufacture of Coin Full Cell

LiNi_{0.5}Co_{0.2}Mn_{0.3} as cathode active material, a polyvinylidene fluoride (PVDF) binder, and carbon as a conducting agent were mixed in a weight ratio of 92:4:4, and then dispersed in N-methyl-2-pyrrolidone to prepare a cathode active material layer composition. The cathode active material layer composition was coated on an aluminum foil having a thickness of 20 μm, dried and then pressed to manufacture a cathode.

A crystalline artificial graphite as anode active material and a polyvinylidene fluoride (PVDF) binder were mixed in a weight ratio of 92:8, and then dispersed in N-methyl-2-pyrrolidone to prepare an anode active material layer composition. The anode active material layer composition was coated on a copper foil having a thickness of 15 μm, dried and then pressed to manufacture an anode.

The cathode and the anode with a 16 μm-thick polyethylene-based separator being disposed therebetween was assembled, and an electrolyte was injected thereinto, thereby manufacturing a 2032-type full coin cell. The injected electrolyte was the electrolyte of Example 1.

### Manufacture Examples 2 to 7

### Manufacture of Coin Full Cell

Coin full cells were manufactured in the same manner as in Manufacture Example 1, except that the electrolytes of Examples 2 to 7, instead of the electrolyte of Example 1, were used, respectively.

### Comparative Manufacture Examples 1 to 3

### Manufacture of Coin Full Cell

Coin full cells were manufactured in the same manner as in Manufacture Example 1, except that the electrolytes of Comparative Examples 1 to 3, instead of the electrolyte of Example 1, were used, respectively.

### Evaluation Example 1

### Evaluation of Charge-Discharge Characteristics and Lifetime Characteristics

### 1) Coin Full Cells of Manufacture Examples 1 to 3 and Comparative Manufacture Example 1

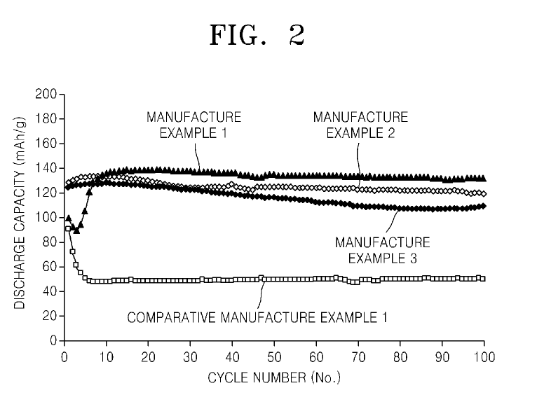

Charge-discharge characteristics of the coin full cells of Manufacture Examples 1 to 3 and Comparative Manufacture Example 1 were measured using a charger/discharger (Model: TOYO-3100, available from TOYO SYSTEM Co., Ltd) to evaluate lifetime characteristics. The results are shown in FIG. 2.

A first cycle of charging and discharging was performed at 0.1 C, a charge potential) of 4.2V (1/50 cut-off), and a discharge potential of 3.0V, and a second cycle of charging and discharging was performed at 0.2 C, a charge potential of 4.2V (1/20 cut-off), and a discharge potential of 3.0V. From the second cycle onward, charging and discharging were performed at 0.5 C, a charge potential of 4.2V (1/20 cut-off), and a discharge potential of 3.0V.

### 2) Coin Full Cells of Manufacture Examples 4 and 5 and Comparative Manufacture Examples 2 and 3

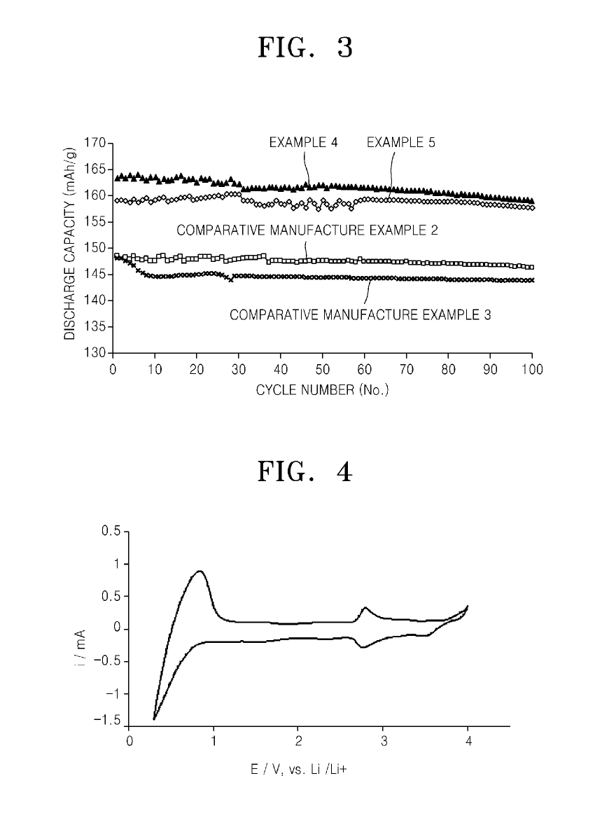

Charge-discharge characteristics of the coin full cells of Manufacture Examples 4 and 5 and Comparative Manufacture Examples 2 and 3 were measured to evaluate lifetime characteristics. The results are shown in FIG. 3. A first cycle of charging and discharging was performed at 0.1 C, a charge potential of 4.2V (1/50 cut-off), and a discharge potential of 3.0V, and a second cycle of charging and discharging was performed at 0.2 C, a charge potential of 4.2V (1/20 cut-off), and a discharge potential of 3.0V. From the second cycle onward, charging and discharging were performed at 0.5 C, a charge potential of 4.2V (1/20 cut-off), and a discharge potential of 3.0V.

Referring to FIG. 3, the coin full cells of Manufacture Examples 4 and 5 were found to have improved discharge capacities compared to those of Comparative Manufacture Examples 2 and 3.

### Evaluation Example 2

### Cyclic Voltammetry Evaluation

Triode cells were manufactured using a graphite electrode as an operating electrode, lithium metal electrodes as a reference electrode and a counter electrode, and the electrolytes of Examples 6 and 7 and Comparative Example 1.

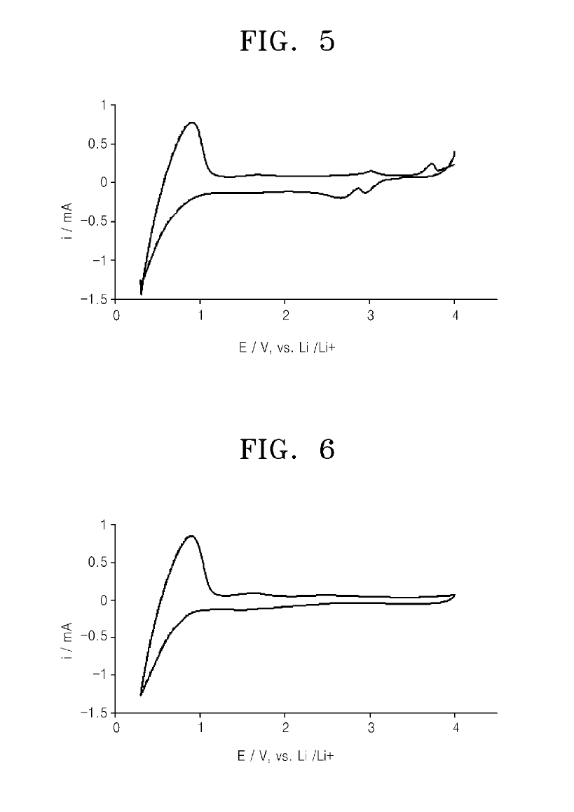

The triode cells including the electrolytes of Examples 6 and 7 and Comparative Example 1, respectively, were analyzed by cyclic voltammetry at a scan rate of about 20 mV/s. The results of the cyclic voltammetric analysis are shown in FIGS. 4 to 6.

Referring to FIG. 4, the triode cell including the electrolyte of Example 6 (including the compound of Formula 2) was found to be decomposed by reduction at about 3.7V and about 3.0 V (with respect to Li/Li⁺). Referring to FIG. 5, the triode cell including the electrolyte of Example 7 (including the compound of Formula 3) was found to decomposed by reduction at about 3.2V and about 2.8 V (with respect to Li/Li⁺).

Unlike the triode cells including the electrolytes of Examples 6 and 7, no peak appeared from the triode cell including the electrolyte of Comparative Example 1, prepared using the nonaqueous organic solvent without an addition of a compound, as illustrated in FIG. 6.

### Evaluation Example 3

### Charge-Discharge Capacity

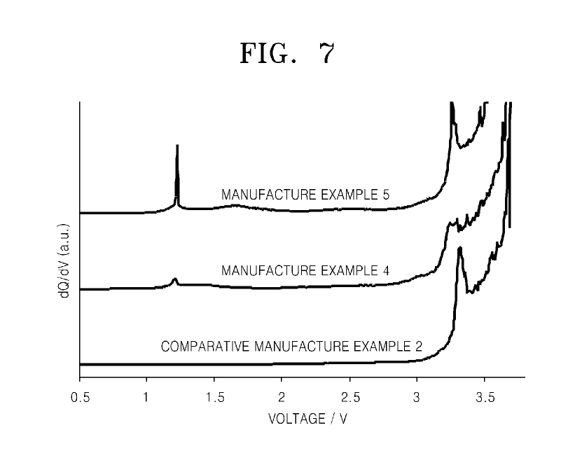

The coin full cells of Manufacture Examples 4 and 5 and Comparative Manufacture Example 2 were charged at 0.1 C to a voltage of 4.3V and then discharged at 0.1 C to a voltage of 3.0V to evaluate charge-discharge capacities. The results are shown in FIG. 7.

FIG. 7 is a graph of dQ/dV versus voltage, illustrating charge-discharge capacity characteristics of the coin full cells of Manufacture Examples 4 and 5 and Comparative Manufacture Example 2 at a rate of 0.2 C. Referring to FIG. 7, it was found that reduction of EC in the anode occurred at about 3.2 V. Decomposition of the electrolyte component in the full coin cell of Comparative Manufacture Example 2 occurred earlier at about 1.2V, resulting in formation of a thin film, compared to the coin full cells of Manufacture Examples 4 and 5.

### Evaluation Example 4

### Fourier Transform Infrared Spectroscopic (FT-IR) Analysis

The coin full cells of Manufacture Examples 4 and 5 and Comparative Manufacture Example 1 were charged at 1 C to a voltage of 4.3V and then discharged at 0.1 C to a voltage of 3.0V. After repeating this cycle 100 times, the anode of each of the full coin cell was analyzed by FR-IR.

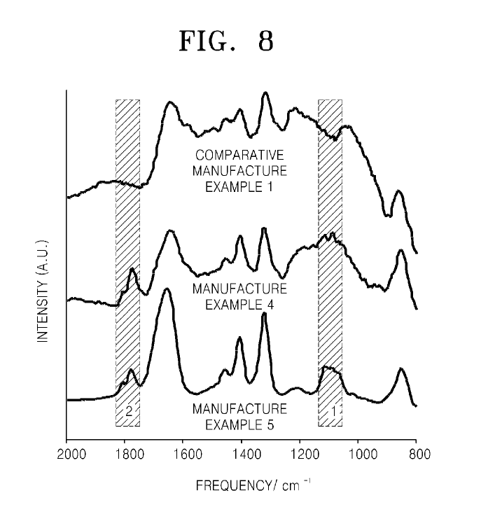

For the RF-IR, after the 100^{th} cycle, each full coin cell was disassembled in a glove box to take the anode, which was then washed with DMC and dried for about 0.5 hour. The results of the FR-IR analysis are shown in FIG. 8.

Referring to FIG. 8, unlike the anode of the full coin cell of Comparative Manufacture Example 1, two new absorption bands appeared from the anodes of the fuel coin cells of Manufacture Examples 4 and 5. These absorption bands from the two anodes of Manufacture Examples 4 and 5 are attributed to the reaction products, e.g., decomposition products, of the compounds of Formulae 2 and 3, respectively, used in the electrolytes, or the reaction products of these decomposition products with ethylene carbonates, i.e., EC and DMC, used in the electrolytes.

As described above, according to the one or more of the above embodiments, a lithium secondary battery with improve cycle characteristics may be manufactured using any of the electrolytes according to the above-embodiments.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. An electrolyte for a lithium secondary battery, the electrolyte comprising:
a compound represented by Formula 1 below;
a nonaqueous organic solvent; and
a lithium salt: 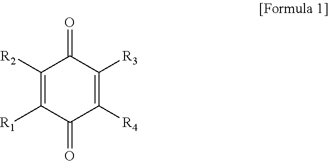
wherein, in Formula 1, R¹, R², R³, and R⁴ are each independently a unsubstituted or substituted C1-C20 alkoxy group, a unsubstituted or substituted C1-C20 alkoxyalkyleneoxy group, a unsubstituted or substituted C₆-C₂₀ aryloxy group, or R—O—C(═O)— where R is a C1-C20 alkyl group, a C₆-C₂₀ aryl group, or a C1-C20 fluoroalkyl group.

2. The electrolyte of claim 1, wherein the compound of Formula 1 is a compound represented by Formula 2 below.

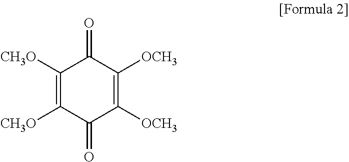

3. The electrolyte of claim 1, wherein the compound of Formula 1 is a compound represented by Formula 3 below:

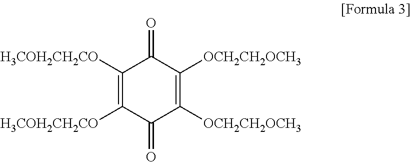

4. The electrolyte of claim 1, wherein an amount of the compound of Formula 1 is from about 0.01 wt % to about 5 wt %.

5. The electrolyte of claim 1, wherein an amount of the compound of Formula 1 is from about 0.1 wt % to about 2.5 wt %.

6. The electrolyte of claim 1, wherein the nonaqueous organic solvent is at least one selected from a carbonate-based solvent, an ester-based solvent, an ether-based solvent, a ketone-based solvent, an alcohol-based solvent, and an aprotic solvent.

7. The electrolyte of claim 1, wherein the nonaqueous organic solvent is at least one selected from dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), acetonitrile, succinonitrile, N,N-dimethyl sulfoxide, N,N-dimethyl formamide, N,N-dimethyl acetamide, γ-butyrolactone, and tetrahydrofuran.

8. The electrolyte of claim 1, wherein the lithium salt is at least one selected from the group consisting of LiPF₆, LiBF₄, LiSbF₆, LiAsF₆, LiC4F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂(lithium bis(oxalato)borate, LiBOB).

9. The electrolyte of claim 1, wherein a concentration of the lithium salt is from about 0.1 M to about 2.0 M.

10. A lithium secondary battery comprising:
an anode comprising an anode active material including a material allowing reversible intercalation and deintercalation of lithium ions, lithium metal, a lithium metal alloy, a material allowing doping or undoping of lithium, or a transition metal oxide;
a cathode comprising a cathode active material allowing reversible intercalation and deintercalation of lithium; and
a reaction product of an electrolyte comprising:
a compound represented by Formula 1 below;
a nonaqueous organic solvent; and
a lithium salt: 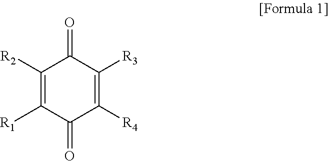
wherein, in Formula 1, R¹, R², R³, and R⁴ are each independently a unsubstituted or substituted C1-C20 alkoxy group, a unsubstituted or substituted C1-C20 alkoxyalkyleneoxy group, a unsubstituted or substituted C₆-C₂₀ aryloxy group, or R—O—C(═O)— where R is a C1-C20 alkyl group, a C6-C20 aryl group, or a C1-C20 fluoroalkyl group.

11. The lithium secondary battery of claim 10, wherein the compound of Formula 1 is a compound represented by Formula 2 below.

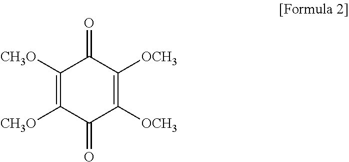

12. The lithium secondary battery of claim 10, wherein the compound of Formula 1 is a compound represented by Formula 3 below:

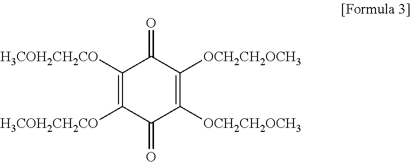

13. The lithium secondary battery of claim 10, wherein an amount of the compound of Formula 1 is from about 0.01 wt % to about 5 wt %.

14. The lithium secondary battery of claim 10, wherein an amount of the compound of Formula 1 is from about 0.1 wt % to about 2.5 wt %.

15. The lithium secondary battery of claim 10, wherein the nonaqueous organic solvent is at least one selected from a carbonate-based solvent, an ester-based solvent, an ether-based solvent, a ketone-based solvent, an alcohol-based solvent, and an aprotic solvent.

16. The lithium secondary battery of claim 10, wherein the nonaqueous organic solvent is at least one selected from dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), acetonitrile, succinonitrile, N,N-dimethyl sulfoxide, N,N-dimethyl formamide, N,N-dimethyl acetamide, γ-butyrolactone, and tetrahydrofuran.

17. The lithium secondary battery of claim 10, wherein the lithium salt is at least one selected from the group consisting of LiPF₆, LiBF₄, LiSbF₆, LiAsF₆, LiC4F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂ (lithium bis(oxalato)borate, LiBOB).

18. The lithium secondary battery of claim 10, wherein a concentration of the lithium salt is from about 0.1 M to about 2.0 M.
